(19) United States
(12) Patent Application Publication
(10) Pub. No.: US 2008/0282902 A1
(43) Pub. Date: Nov. 20, 2008

(54) Automatic cooking appliance shutoff apparatus

(76) Inventors: Douglas C. Dayton, Harvard, MA (US); Elizabeth Johansen, Somerville, MA (US); Angie Kim, San Francisco, CA (US); Sung K. Park, Newton, MA (US)

Correspondence Address: MINTZ, LEVIN, COHN, FERRIS, GLOVSKY;and POPEO, P.C., One Financial Center, Boston, MA, 02111, US

(21) Appl. No.: 12/008,102

(22) Filed: Jan. 7, 2008

Related U.S. Application Data
(60) Provisional application No. 60/879,308, filed on Jan. 5, 2007.

(51) Int. Cl. H05B 1/00; A47J 37/00

(52) U.S. Cl. 99/331; 99/332; 219/492

(57) ABSTRACT

The invention relates to an apparatus used for automatically shutting off cooking appliances, such as ovens, stoves, hot pots, toasters, grills, and others. More specifically, the apparatus is secured to a cooking appliance, e.g. to its control panel, and may prevent a cooking appliance from being turned on before a timer is set. The apparatus can also increase the ease with which a cooking appliance knob or other actuator may be used. To automatically shutoff the cooking appliance, the apparatus uses a timing mechanism with a spring. Pressure is exerted on a spring when the timer is set, storing enough force in the spring to enable it to turn the cooking appliance to the OFF position when time has expired. A mechanical stop is in place to keep the spring energy from releasing until the timer reaches the OFF position.

### PRIOR PATENT APPLICATION

This application is a non-provisional patent application claiming priority to U.S. provisional patent application Ser. No. 60/879,308 filed on Jan. 5, 2007, the disclosure of which is incorporated herein in its entirety by reference.

### TECHNICAL FIELD

The invention is directed to an apparatus used for automatically shutting off cooking appliances, such as ovens, stoves, hot pots, toasters, grills, and others.

### BACKGROUND

Conventional cooking appliance knobs are typically connected directly to the cooking appliance, such as an oven or stove, and may be rotated at any time to turn on the cooking appliance. A typical cooking appliance will stay at the chosen heat setting until a cooking appliance knob is manually turned to the OFF position. Controlling the operation of a cooking appliance in this manner presents the danger that a person who turned the appliance on will forget to turn it off, presenting the risk of a fire hazard or other danger.

Older adults are more likely to forget to turn off a cooking appliance due to the increased possibility of their diminished mental faculties. Among those persons aged 65 and older, 15 percent of men and 11 percent of women suffer from some form of moderate to severe memory impairment, according to the 2002 Federal Interagency Forum on Aging-Related Statistics. Also, according to the Alzheimer's Association, one in ten people who are 65 years and older are afflicted with Alzheimer's Disease. Decreased sensory abilities, such as smell, touch, vision and hearing, in older adults places them at a higher risk of forgetting about cooking appliances and, thus, at a higher risk of death or injury from cooking appliance fires.

Therefore, addressing the special needs of the elderly with regard to cooking appliances and the dangers present in accidentally leaving a cooking appliance on is desirable.

### SUMMARY

The invention provides an apparatus that prevents a cooking appliance from being turned on before a timer is rotated from the OFF position. In addition the invention provides an apparatus that increases the ease with which a cooking appliance knob or other actuator may be rotated or actuated.

More particularly, the invention is directed to an apparatus configured as a replacement knob, which can be installed in place of or in addition to an existing original equipment manufacturers (OEM) removable knob for a conventional cooking appliance to help to prevent the cooking appliance from being accidentally left on for an undesirable amount of time. The invention further provides an apparatus that automatically shuts off a cooking appliance at a specified time.

In general, in an aspect, the invention provides an apparatus including a frame with an adhesive backing to secure the device to a cooking appliance, an inner heat-setting control mounted to the frame and an outer timer control mounted to the frame. The outer timer control is adapted to engage with the heat-setting control and to inhibit the heat-setting control from being turned when the timer control is in the OFF position. The device further includes a knob shaft connected to the heat-setting control that protrudes from the back of the device and may be connected to a knob or other structure that controls operation, e.g. on and off functions, of a cooking appliance. A wheel or gear is connected to the timer control and is adapted to contact or engage with a cooking appliance knob shaft or other structure that controls the cooking appliance operation so that the wheel or gear may inhibit the cooking appliance knob shaft from being turned when the timer control is in the OFF position.

Capabilities and advantages of the invention may include one or more of the following. An automatic cooking appliance shutoff apparatus may be used along with or in place of an existing original equipment manufacturers (OEM) removable knob or other structure used to control the operation of a conventional cooking appliance. The shutoff apparatus may inhibit a heat-setting control from being turned, when a timer control is in the OFF position, preventing the cooking appliance from being turned on before a cooking time is set. Once the timer is set, the shutoff apparatus may enable the heat-setting control to be easily turned to the desired heat preference. When the set time has elapsed, the heat-setting control may be driven back to the OFF position, e.g. by the energy of an internal spring, to turn the cooking appliance off.

The automatic cooking appliance shutoff apparatus may be constructed and arranged as a replacement knob to couple with an existing operating knob of a cooking appliance. The apparatus may be configured to accommodate a standard D-shaped cooking appliance knob shaft or a wide variety of other cooking appliance knob shaft profiles using a knob shaft insert. An appropriate knob shaft insert may enable the apparatus to engage the cooking appliance knob shaft, allowing the cooking appliance knob shaft to rotate with the apparatus away from the OFF position, when a heat-setting control of the apparatus is turned. An adhesive backing may create a mechanical base or foundation, holding a portion of the apparatus stable in relation to the cooking appliance and allowing the apparatus to achieve the torque needed to turn the cooking appliance knob shaft to the OFF position. The apparatus may also facilitate persons with diminished strength and manual dexterity to use a cooking appliance knob or other structure for its operation by reducing the force needed to turn such knob or structure of the appliance.

The timer control and the heat-setting control of the apparatus may be marked and labeled to indicate their function, and may include text and/or graphics for setting preferences, such as temperature. The text or graphics may be large enough to make them easy to read for those persons with limited eyesight, and may be familiar to make them easy to understand by those persons with diminished mental capacities. The angular placement of text or graphics may be the same as the most prevalent text scheme appearing on a cooking appliance knob or other structures for operation of the cooking appliance.

### BRIEF DESCRIPTION OF THE DRAWINGS

FIG. 1A is a front perspective view of an exemplary apparatus according to the invention;

FIG. 1B is a back perspective view of the apparatus shown in FIG. 1A;

FIG. 2 is a perspective view of the apparatus shown in FIG. 1 to be coupled to a knob shaft of an existing operation knob or structure of a cooking apparatus;

FIG. 3 is a cross-sectional view of the apparatus shown in FIGS. 1A and 1B and FIG. 2 during one stage of its operation;

FIG. 4A is a cross-sectional view of the apparatus shown in FIGS. 1A and 1B and FIG. 2 during another stage of its operation;

FIG. 4B is a cross-sectional view of the apparatus shown in FIGS. 3 and 4A;

FIG. 5 is a cross-sectional view of the apparatus shown in FIGS. 1A and 1B and FIG. 2 during a further stage of operation;

FIG. 6A is a front perspective view of another exemplary apparatus according to the invention;

FIG. 6B is a back perspective view of the apparatus shown in FIG. 6A;

FIG. 7 is a perspective view of the apparatus shown in FIGS. 6A and 6B mounted to an oven control panel;

FIG. 8 is a perspective view of the apparatus shown in FIGS. 6A and 6B and FIG. 7 with electronic controls; and

FIG. 9 is a perspective view of a further apparatus according to the invention.

### DETAILED DESCRIPTION

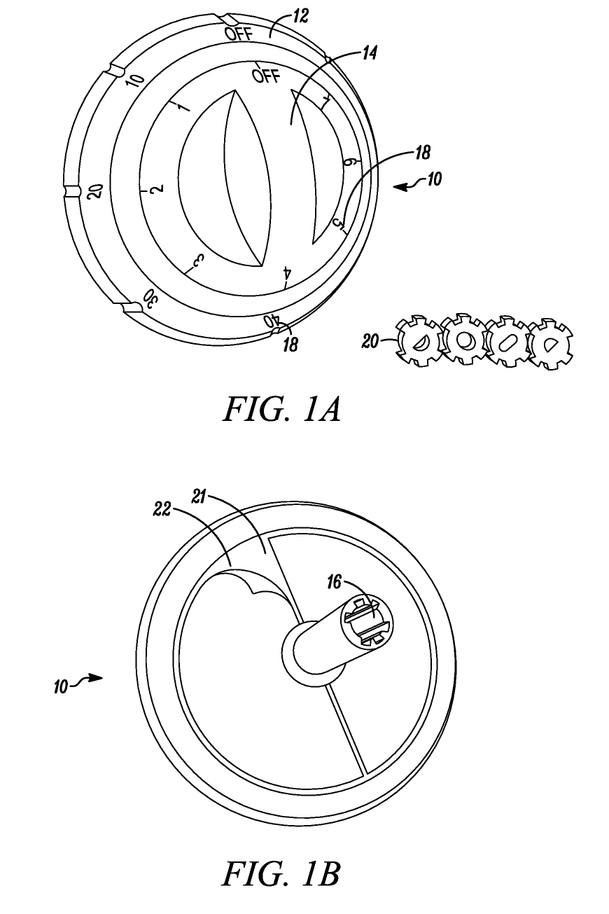

Referring to FIGS. 1A and 1B, in an aspect, the invention provides an automatic cooking appliance shutoff apparatus 10 constructed and arranged as a replacement knob for installing in place of a conventional OEM removable knob or other actuator of a conventional cooking appliance. The replacement knob 10 includes a frame 21, an outer timer control 12, an inner heat-setting control 14, and a knob shaft 16. The timer control 12 is mounted to the frame 21 such that it can pivot or rotate in relation to the frame 21. A heat-setting control 14 is operatively connected to the timer control 12 and moveable in relation to both the frame 21 and the timer control 12.

The replacement knob 10 adheres or is otherwise affixed to a cooking appliance, e.g., its control panel using an adhesive backing 22 or other means on the frame 21. The adhesive backing 22 or other means on the frame 21 creates a mechanical base or foundation, holding a portion of the replacement knob 10 stable in relation to a cooking appliance and allowing the replacement knob 10 to achieve the torque needed to turn the knob shaft 16 back to the OFF position, e.g. from an ON position.

The timer control 12 and the heat-setting control 14 may be marked and labeled to indicate their function, and may include text and/or graphics 18 for highlighting preferences, such as temperature. The text and/or graphics 18 may be large enough to make them easy to read for those with limited eyesight, and may be common to make the text or graphics 18 easy to understand by those with diminished mental capacities. The angular placement of the text or graphics 18 may be the same as the most prevalent text scheme appearing on cooking appliance knobs.

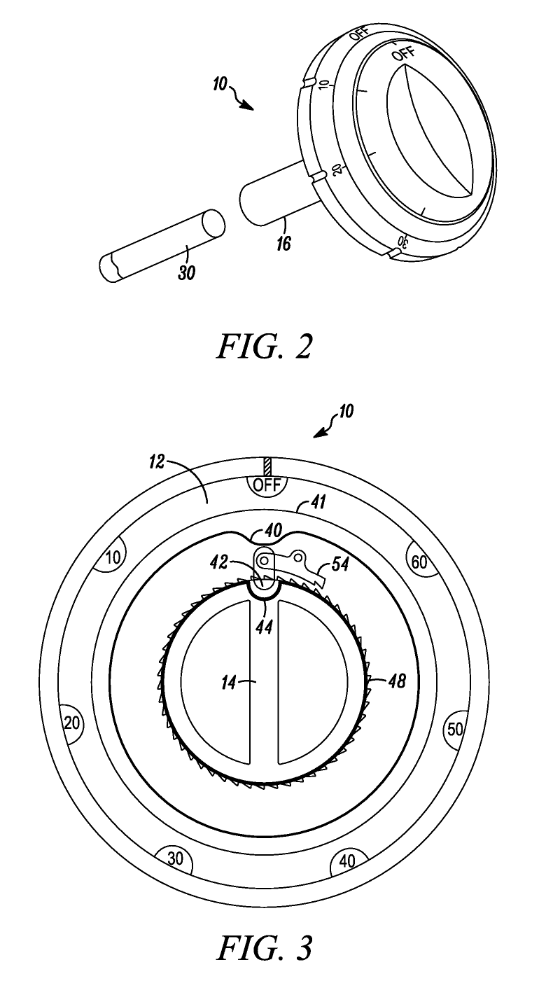

Referring to FIG. 2, and with further reference to FIGS. 1A and 1B, the knob shaft 16 is connected to the heat-setting control 14 and protrudes from the back of the replacement knob 10. The knob shaft 16 is configured to connect to an appliance knob shaft 30 or other structure that is configured and adapted to help to control the operation, e.g., setting temperature and/or turning operation ON or OFF, of a cooking appliance. In one embodiment, the replacement knob 10 may accommodate a standard D-shaped cooking appliance knob shaft 30 or a wide variety of other cooking appliance knob shaft profiles using a knob shaft insert 20, shown in FIG. 1A. The knob shaft insert 20 fits inside and engages with the knob shaft 16 of the replacement knob 10. The appropriate knob shaft insert 20 may enable the knob shaft 16 to engage a cooking appliance knob shaft 30, allowing the cooking appliance knob shaft 30 to rotate with the knob shaft 16, e.g., away from an OFF position when the heat-setting control 14 is turned.

The timer control 12 inhibits the heat-setting control 14 from being turned when the timer control 12 is in the OFF position. Referring to FIG. 3, when the timer control 14 is in the OFF position, a cam 40 along an inner surface 41 of the timer control 12 depresses a cam follower 42. By depressing the cam follower 42, the cam 40 causes the cam follower 42 to engage into a recess 44 on a circumference of the heat-setting control 14. Engagement of the cam follower 42 into the recess 44 causes the cam follower 42 to inhibit the heat-setting control 14 from turning.

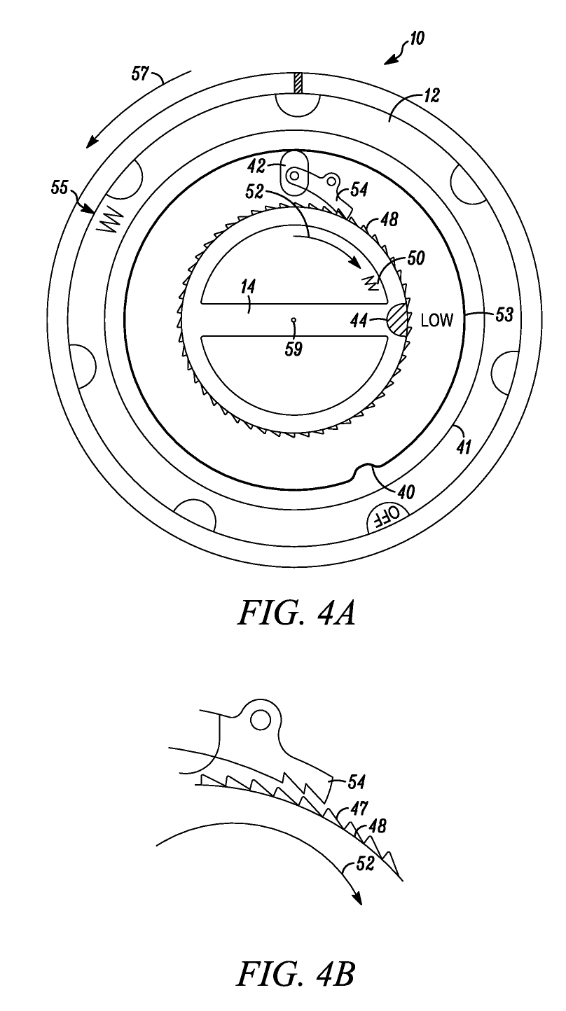

Referring to FIGS. 4A and 4B, turning the timer control 12 to set a cooking time requires compressing a spring 55, generally disposed in the apparatus to operatively couple with the timer control 12. The timer control 12 is turned in a counterclockwise motion, as shown by arrow 57, shown in FIG. 4A, against the resistance of the spring 55. Turning the timer control 12 stores energy in the spring 55, which allows the timer to wind down as the set time elapses.

The cam 40 along the inner surface 41 of the timer control 12 rotates with the timer control 12 on the axis 59, shown in FIG. 4A. When the timer control 12 is turned in a counterclockwise motion, as shown by an arrow 57 in FIG. 4A, the cam 40 rotates in the same counterclockwise motion. This counterclockwise rotation causes the cam 40 to move away from the cam follower 42. As the cam 40 moves away, the cam follower 42 moves from the cam 40 to the cam barrel 53. By moving to the cam barrel 53, the cam follower 42 moves outward, away from the heat-setting control 14, and the cam follower 42 disengages from the recess 44 in the heat-setting control 14.

Once the cam follower 42 has disengaged from the recess 44 in the heat-setting control 14, the heat-setting control 14 can now be turned clockwise, as shown by an arrow 52 in FIGS. 4A and 4B. A toothed pawl 54 is operatively connected to the cam follower 42 such that movement of the cam follower 42 onto the cam 40 and off of the cam 40 pivots a toothed pawl 54. When the cam follower 42 moves outward to the cam barrel 53, the toothed pawl 54 is pivoted against a toothed wheel 48. The toothed wheel 48 is connected to the circumference of the heat-setting control 14. When the heat-setting control 14 is turned, compliance provided by the toothed pawl's 54 connection to the cam follower 42 enables the reverse inclined teeth 47 on the toothed wheel 48 to slip past the toothed pawl 54.

The level of heat may be set by turning the heat-setting control 14 clockwise, as shown by an arrow 52 in FIGS. 4A and 4B, against pressure from spring 50. Turning the heat-setting control 14 loads the internal spring 50 with the force necessary to return the heat-setting control 14 to its OFF setting. As the heat-setting control 14 moves in a clockwise position, as shown by an arrow 52 in FIGS. 4A and 4B, the toothed wheel 48 moves against the pawl 54 and the pawl 54 floats up the ramps of the reverse inclined teeth 74. When the heat-setting control 14 is set to a preferred heat setting, the pawl 54 engages with the reverse inclined teeth 47. The engagement of the pawl 54 and the reverse inclined teeth 74 on the toothed wheel 48 prevent the heat-setting control 14 from turning. The heat-setting control 14 cannot return to its OFF position until the pawl 54 is removed from its engagement with the toothed wheel 48.

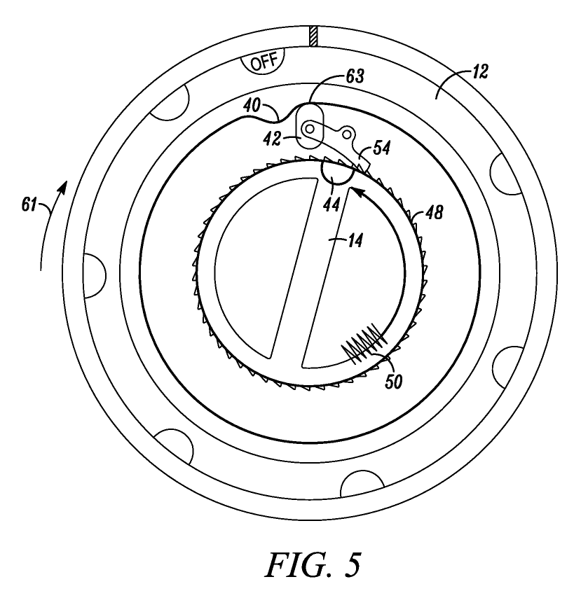

Referring to FIG. 5, after the timer control 12 is set to a desired time, the timer control 12 rotates clockwise, as shown by an arrow 61 in FIG. 5, as the timer control 12 times down to the end of a cycle. As part of the timer control 12, the cam 40 also travels clockwise during this time, as shown by an arrow 61 in FIG. 5. As the cam 40 travels clockwise, the leading ramp 63 of the cam 40 encounters the cam follower 42. The leading ramp 63 of the cam 40 starts to move the cam follower 42 toward the heat-setting control 14. As the cam follower 42 is moved toward the heat-setting control 14, the pawl 54 is pivoted away from the toothed wheel 48. This causes the pawl 54 to disengage from the reverse inclined teeth 74 on the toothed wheel 48 of the heat-setting control 14.

Released from the pawl 54, the heat-setting control 14 is driven back to the OFF position by the energy of the internal spring 50. As the heat-setting control 14 turns back to the OFF position, the knob shaft 16, connected to the heat-setting control 14 and coupled with appliance knob shaft 30, is also returned to the OFF position. With the heat-setting control 14 returned to the OFF position as the timer control 12 returns to the OFF position, the cam follower 42 is driven onto the highest ramp of the cam 40. This forces the cam follower 42 to engage into the recess 44 on the circumference of the heat-setting control 14. Engagement of the cam follower 42 into the recess 44 causes the cam follower 42 to inhibit the heat-setting control 14 from turning and locks the heat-setting control 14 until the timer control 12 is used again.

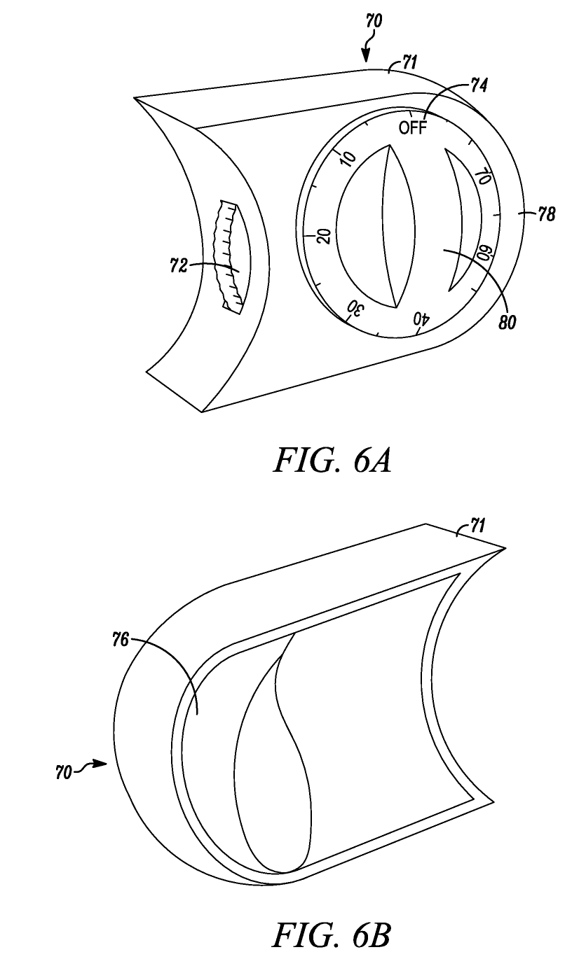

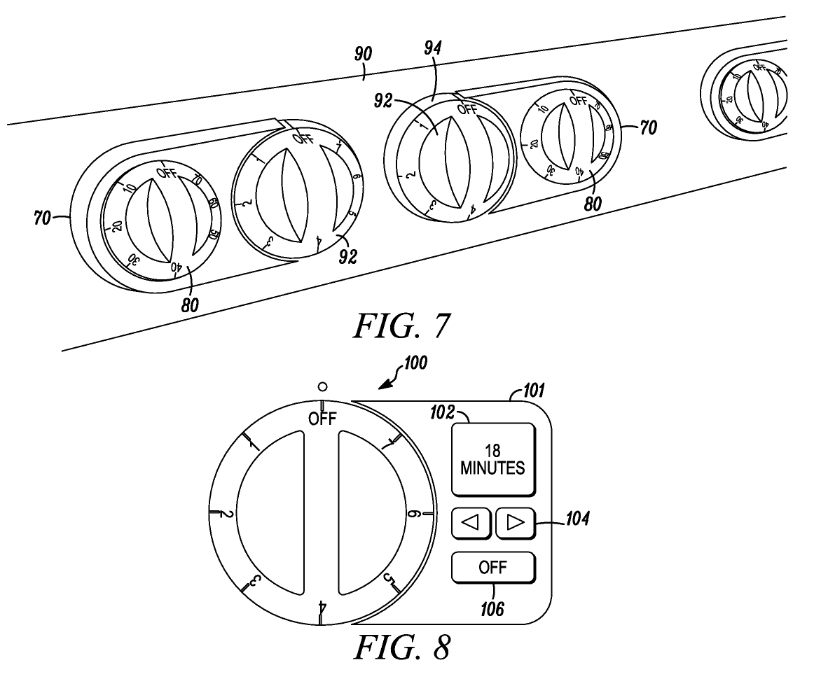

Referring to FIGS. 6A-7, another embodiment of the invention provides a knob-turning apparatus 70 including a frame 71, a friction wheel 72 and a timer control 80. The timer control 80 is mounted to the frame 71 such that it can pivot or rotate in relation to the frame 71. The friction wheel 72 is operatively connected to the timer control 80 and moveable in relation to both the frame 71 and the timer control 80. The knob-turning apparatus 70 is adhered to a cooking appliance control panel 90, shown in FIG. 7, by an adhesive backing 76 on the frame 71. The adhesive backing 76 holds the knob turning apparatus 70 stable with relation to the cooking appliance itself. The adhesive backing 76 also provides stability for operation and allows the knob-turning apparatus 70 to achieve the torque needed to turn the OEM cooking appliance knob 92 back to the OFF position.

Turning the timer control 80 to set a cooking time requires compressing the spring of a mechanical kitchen timer mechanism. The spring is generally disposed in the apparatus 70 to operatively couple with the timer control 80. The timer control 80 is turned against the resistance of the spring. Turning the timer control 80 stores energy in the spring, which allows the timer to wind down. The mechanical kitchen timer mechanism in the knob-turning apparatus 70 is connected to a friction wheel 72. The friction wheel 72 is mounted to the cooking appliance control panel 90 such that the friction wheel 72 is in contact with either the outer edge of the OEM cooking appliance knob 92 or the cooking appliance knob shaft 30, as shown in FIG. 2. The contact between the friction wheel 72 and either the OEM cooking appliance knob 92 or the cooking appliance knob shaft 30 is such that it may prevent the OEM cooking appliance knob 92 from turning.

In an additional embodiment of the knob-turning apparatus 70, a frictional or gear component around an outer diameter 94 of the OEM cooking appliance knob 92 may engage with a mating friction wheel 72 or gear wheel on the knob-turning apparatus 70. Further frictional grip can be achieved through application of a circumferential adhesive strip to the outer diameter 94 of the OEM cooking appliance knob 92.

The knob-turning apparatus 70 includes an engaged rotating gear attached to a wound-up clock spring that prevents the friction wheel 72 from being turned when the timer control 80 is set to the OFF position. Contact between the friction wheel 72 and the OEM cooking appliance knob 92 may prevent the OEM cooking appliance knob 92 from being turned when the friction wheel 72 is not free to turn. Therefore, when the timer control 80 is set to the off position, the OEM cooking appliance knob 92 may not be turned. When the timer control 80 is set to any position other than the OFF position, the rotating gear is disengaged, enabling the friction wheel 72 and OEM cooking appliance knob 92 to turn.

Force is stored in a clock spring when the timer control 80 is turned away from the OFF position. When the timer control 80 returns to the OFF position, the rotating gear re-engages the friction wheel 72 and the clock spring's energy is released, rotating the friction wheel 72 such that the OEM cooking appliance knob 92 returns to the OFF position.

In an embodiment of the invention, the friction wheel 72 may reduce the force needed to turn the OEM cooking appliance knob 92 when the timer is not set to the OFF position by using an opposing clock spring. The opposing clock spring may apply a torque to the friction wheel 72 that is slightly less than the torque needed to turn the OEM cooking appliance knob 92. As the OEM cooking appliance knob 92 is turned, the friction wheel 72 turns easily. When the timer control 80 returns to the OFF position, the rotating gear re-engages the friction wheel 72 and the primary clock spring's energy is released, turning the friction wheel 72 such that the OEM cooking appliance knob 92 turns to the OFF position.

The timer control 80 may be marked and labeled to indicate its function, and may include text and/or graphics 74 for highlighting the time. The text and/or graphics 74 may be large enough to make them easy to read for persons with limited eyesight, and may be common to make the text or graphics 18 easy to understand by persons with diminished mental capacities. The angular placement of the text or graphics 18 may be the same as the most prevalent text scheme appearing on cooking appliance knobs.

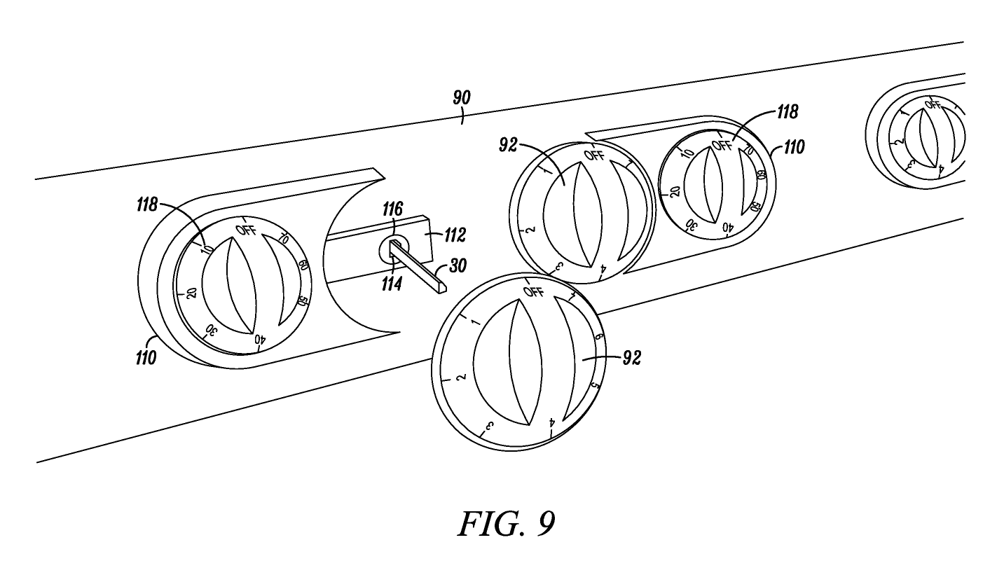

Referring to FIG. 8, and with further reference to FIGS. 1A-7, an embodiment of the invention provides an electronic knob-turning apparatus 100 including a frame 101, timer buttons 104, a display of time remaining 102, and an off button 106 to reset the timer to OFF. The timer buttons 104, the display of time remaining 102, and the off button 106 are connected to the frame 101 and are located adjacent to each other. The frame 101 may be adhered to a cooking appliance control panel using an adhesive backing on the frame 101.

In another embodiment of the replacement knob 10, shown in FIGS. 1A-5, an electronic timer may replace the manual timer control 12. The electronic timer relays user input through an electronic interface to a small motor, which is attached to the cam barrel 53. Manual pressure on the timer buttons 104 may set the time, which is displayed on the display of time remaining 102. When the time is set, a motor rotates the cam 40 away from the OFF position. By rotating the cam 40 away from the OFF position, the cam follower 42 moves off the cam 40 and moves to the outer surface of the cam barrel 53. This movement off the cam 40 disengages the cam follower 42 from the recess 44 in the heat-setting control 14. Once the cam follower 42 is disengaged from the recess 44, the heat-setting control 14 is free to turn. Turning the heat-setting control 14 loads an internal spring 55 such that it can return the heat-setting control 14 to its OFF position.

When the time expires, the electronics relay a signal to the motor, turning the cam 40 back to its original OFF position. This enables the leading ramp of the cam 40 to depress the cam follower 42. Depressing the cam follower 42 lifts the pawl 54 out of its engagement with the toothed wheel 48, causing the heat-setting control 14 to be driven back to the OFF position by the energy of the internal spring 50. Once the cam 40 is back to its OFF position, the motor takes a stable position. A visual or acoustical signal or alarm may be activated in conjunction with this action.

Referring to FIG. 8, and with further reference to FIGS. 6A-7, in another embodiment of the knob-turning apparatus 70, an electronic timer may be used to relay user input through an electronic interface to a small motor, which is attached to a friction wheel 72. The friction wheel 72 is in contact with the side of the OEM cooking appliance knob 92 or attached directly to the cooking appliance knob shaft 30. The friction wheel exerts a force against the OEM cooking appliance knob 92 that may prevent or resist turning of the OEM cooking appliance knob 92 when the timer is set to OFF. When the timer is set to some number greater than zero, the user is free to turn the OEM cooking appliance knob 92. Once the time expires, the electronics relay a signal to the motor, turning the OEM cooking appliance knob 92 until a sensor receives a signal that the torque is high enough to indicate the OEM cooking appliance knob 92 has arrived at the OFF position. At this point, the motor stops turning the friction wheel 72 and takes a stable position. A visual or acoustical signal or alarm may be activated in conjunction with this action.

An electronic embodiment may also include input to set heat, and the motor may turn the OEM cooking appliance knob 92 to the appropriate heat level for the user. If the motor can set the heat level, the OEM cooking appliance knob 92 may be programmed to be set to a certain heat level for a specified amount of time, and then changed to a different heat level, accommodating more complicated recipes, or the ability to automatically keep food warm for a period of time after it is done cooking. Also, the motor may reduce the torque needed to turn the OEM cooking appliance knob 92.

Referring to FIG. 9, and with further reference to FIGS. 2 and 6A-7, another embodiment of the knob turning apparatus 70 is a knob-turning apparatus 110, which includes an extended portion 112 that engages with the cooking appliance knob shaft 30. To install the knob-turning apparatus 110, the OEM cooking appliance knob 92 is removed and the knob-turning apparatus 110 is placed around the cooking appliance knob shaft 30. The cooking appliance knob shaft 30 extends through a hole 114 in the extended portion 112 of the knob-turning apparatus 110. The cooking appliance knob shaft 30 engages with the rotating gear 116 in the extended portion 112. The hole 114 may accommodate a standard D-shaped cooking appliance knob shaft 30 or a wide variety of other cooking appliance knob shaft profiles.

The knob-turning apparatus 110 is adhered to the cooking appliance control panel 90 using an adhesive backing, and the OEM cooking appliance knob 92 is placed back onto the cooking appliance knob shaft 30, disposed further away from the control panel 90. A gear train located inside the extended portion 112 engages with the rotating gear 116 to prevent the cooking appliance knob shaft 30 from turning when the timer control is set to the OFF position, and turns the cooking appliance knob shaft 30 back to the OFF position when the time has expired. When the timer control 118 is set, the OEM cooking appliance knob 92 may be turned, rotating the cooking appliance knob shaft 30 and turning on the cooking appliance.

Having described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An apparatus for shutting off cooking appliances comprising:
a frame;
an adhesive backing adhered to said frame;
a heat-setting control mounted to said frame;
a knob shaft connected to said heat-setting control;
a timer control adapted to engage said heat-setting control;
wherein said knob shaft couples with an appliance knob shaft

2. An apparatus for shutting off cooking appliances comprising:
a frame;
an adhesive backing on said frame;
a timer control connected to said frame;
a wheel connected to said timer control and adapted to contact or engage with a cooking appliance shaft or knob

3. An electronic knob-turning apparatus comprising:
a frame;
an adhesive backing on said frame;
a time remaining display connected to said frame;
a timer buttons connected to said frame and disposed adjacent to said time remaining display;
an off button connected to said frame and disposed adjacent to said timer buttons;
a wheel connected to said timer control and adapted to contact or engage with a cooking appliance shaft or knob

4. (canceled)
